(19) United States
(12) Patent Application Publication
(10) Pub. No.: US 2004/0205720 A1
(43) Pub. Date: Oct. 14, 2004

(54) Augmenting debuggers

(76) Inventor: Robert Hundt, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/846,222

(22) Filed: Apr. 30, 2001

(51) Int. Cl. G06F 9/44

(52) U.S. Cl. 717/124

(57) ABSTRACT

The present invention, in various embodiments, provides techniques for adding capabilities to a debugger for a user to debug a program more efficiently. In one embodiment, when the debugger and the program are run, one or more breakpoints are reached. At each breakpoint, the program is stopped, a debugging prompt is provided to the user, and the user enters debugging commands. In one embodiment, to execute the user's commands, the debugger, based on the commands, requests an instrumentor to create the debugging code in the executable context of the program under debug. The user then allows the program to continue execution. Because the debugging code is an executable part of the program, it is executed when it is reached while the program is being executed, resulting in faster execution of the debugging commands.

### FIELD OF THE INVENTION

The present invention relates generally to debugging program code and, more specifically, to augmenting debuggers.

### BACKGROUND OF THE INVENTION

A debugger is a program assisting programmers to find “bugs” or errors in other programs. Typically, a debugger allows a programmer to stop at breakpoints inserted in the program so that the programmer can perform debugging functions. At each breakpoint, the programmer examines and changes the value of the program variables, redirects the program flow, single steps the program, etc. Although debuggers are useful, they, in many instances, lack capabilities to meet programmers' needs, such as to find how often a function is called, how long a function is invoked, what kinds of instructions are executed in a function, etc. Consequently, it is desirable that techniques be provided to solve the above deficiencies and associated problems.

### SUMMARY OF THE INVENTION

The present invention, in various embodiments, provides techniques for adding capabilities to a debugger for a user to debug a target program more efficiently. In one embodiment, when the debugger and the program are run, one or more breakpoints are reached. At each breakpoint, the program is stopped, a debugging prompt is provided to the user, and the user enters debugging commands. In one embodiment, to execute the user's commands, the debugger, based on the commands, requests an instrumentor to create the debugging code in the executable context of the target program. The user then allows the program to continue execution. Because the debugging code is an executable part of the program, it is executed when it is reached while the program is being executed, resulting in faster execution of the debugging commands.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a flowchart illustrating a method in accordance with one embodiment; and

FIG. 2 shows an overview of a computer system upon which embodiments of the invention may be implemented.

### DETAILED DESCRIPTION OF THE PREFERRED EMBODIMENT

The present invention, in various embodiments, provides techniques for augmenting a debugger used to debug a target program. In one embodiment, the debugger is combined with an instrumentor, which advantageously increases the debugger's capabilities, and allows faster execution of various instrumentor code because this code, in many situations, is executed in the target program. However, the invention is not limited to an instrumentor; techniques of the invention are applicable to other programs such as one that can perform functions requested by the user using the debugger. Exemplary debuggers benefiting from the techniques disclosed herein include the standard Unix debuggers “gdb,” “wds,” “kernel gdb,” “kwds,” “Q4,” “xdb,” etc. For illustrative purposes, a debugger is referred to as a “dbgr,” an instrumentor as an “instr,” a program being debugged as a “progA,” a trampoline as a “trmpl,” and a library as a “lib.”

In the following description, for the purposes of explanation, numerous specific details are set forth in order to provide a thorough understanding of the invention. However, it will be apparent to one skilled in the art that the invention may be practiced without these specific details. In other instances, well-known structures and devices are shown in block diagram form in order to avoid obscuring the invention.

### The Instrumentor

Generally, an instrumentor is a program providing code instrumentation or methods for analyzing and evaluating program code, structure, dynamic behavior, performance, etc., of a target program. During code instrumentation, new instructions or probe code are added to the target program, and existing instructions in the program are altered or deleted. Consequently, the original code in the program is changed and/or relocated, resulting in modified or instrumented code. Some examples of probe code include adding values to a register, moving the content of one register to another register, moving the address of some data to some registers, inserting a counter at a function entry point to count the number of function invocations, etc. Code instrumentation may be done statically or dynamically, e.g., while program progA is being executed.

In one embodiment, an instrumentor instr providing code modification and generation capability is combined with a debugger dbgr to provide additional capabilities to debugger dbgr. Further, the “Caliper” by Hewlett-Packard-Company of Palo Alto, Calif. operates as instrumentor instr. Since instrumentor instr can instrument progA dynamically, many debugging functions by debugger dbgr can be improved, e.g., done dynamically. In one embodiment, debugger dbgr runs without instrumentor instr if debugger dbgr does not use the functions of instrumentor instr.

In one aspect, combining instrumentor instr and debugger dbgr allows debugger dbgr to benefit from most functionality of the instrumentor. Further, much functionality of instrumentor instr and debugger dbgr can be executed more efficiently. Additionally, the combined instrumentor instr and debugger dbgr can provide various functions provided by other program development tools. These tools include, for example, the “purify,” “quantify,” “PureCoverage,” and “Visual Test” by Rational Software Corp of Cupertino, Calif., the Unix standard tools “prof” and “gprof,” the “ParaSoft C++ Test” and “ParaSoft C++ Insure” by ParaSoft of Monrocia, Calif., the “Ccover” by Bullseyes Testing Technology of Redmond, Wash., etc. As an example, instrumentor instr, through a trampoline trmpl and debugger dbgr, provides the capability to count the number of times a function is invoked, which is a traditional function of gprof. Further, in accordance with the techniques disclosed herein, the compiling process usually used to integrate tool gprof into program progA may not be necessary while implementing the functionality of gprof. Some other functions performed by the combined instrumentor instr and debugger dbgr include detecting memory leaks, providing instruction histograms, counting function invocations, providing call graphs for a program, checking program correctness, etc.

Instrumentor instr also benefits from the techniques disclosed herein because various code in instrumentor instr, in many situations, is faster executed in program progA.

### The Library

In one embodiment, programming code to perform the functions of the combined instrumentor instr and debugger dbgr are stored in a binary library lib. This library code, depending on the functions, is invoked by debugger dbgr, instrumentor instr, the below integration code IC, or other program code seeking to use this library code. Some examples of instrumentation functionality in library lib include allocating memory, invoking trampolines, modifying code, handling binary code, managing systems, supporting instrumentation, etc.

Examples of binary code handling include handling executable's executable and linking format (ELF) file, its text code segments, symbol and string table, procedure lookup table (PLT), and dynamic tables for strings and symbols; encoding, decoding, scheduling, and templatizing binary instructions of a program and converting these instructions from and to internal representations; preprocessing internal representations and their related problems; identifying and/or generating free registers for probe code, discovering functions, etc.

Examples of system management include allocating memory and mapping memory into target programs (referred to as code injection), managing code blocks in shared memory, e.g., creating space for trampolines, reserving space for instrumented functions and auxiliary data, etc.

Examples of instrumentation support include generating, updating, and retrieving memory locations used as counters, generating probe code, e.g., for updating counters, spilling and filling registers, handling functions for breakpoints, etc.

### The Trampoline

Generally, a trampoline is a piece of programming code performing some desired functions. In one embodiment, trampoline trmpl is invoked to execute instructions input by a user. Trampoline trmpl is used as an example only; the disclosed techniques can utilize various pieces of code, functions, or programs that can execute the commands input by the user. One or more trampolines may be used by program progA. To maintain the behavior of program progA, trampoline trmpl generally includes code to save and restore the state of program progA before instructions in trampoline trmpl are executed. The code to save the state is usually before these instructions, and the code to restore the state is usually after the instructions. The code in trampoline trmpl performing the request from a user advantageously augments debugger dbgr. This is because a conventional debugger usually can only allow breakpoints to be inserted into program progA, but does not provide capability so that the original code can be modified and/or new code can be generated in trampoline trmpl or in progA.

In one embodiment, a branch instruction is inserted into program progA so that, when this branch instruction is executed, the program flow is transferred to trampoline trmpl. If the branch instruction replaces an instruction or a group of instructions in program progA, then trampoline trmpl also includes the code to execute such an instruction or group of instructions. Trampoline trmpl may be in the code section, shared memory, or stacks of program progA. Alternatively, trampoline trmpl can be in progA's process context. However, in all situations, trampoline trmpl is an executable part of progA, which allows efficient execution of instructions in trampoline trmpl when progA is executed. Traditionally, instructions input by the user are interpreted by debugger dbgr, which causes context switches between program progA and debugger dbgr. This greatly degrades system performance, especially when such switches occur repeatedly in code having loops.

In one embodiment, trampoline trmpl is part of library lib usable by debugger dbgr, instrumentor instr, and program progA. Alternatively, trampoline trmpl can be dynamically generated. Those skilled in the art will recognize that a piece of code, e.g., a function fooB having the original code of a function fooA and new code referencing to or including trampoline trmpl is an instrumented function of function fooA.

### The Integration Code

Integration code IC provides mechanisms to combine instrumentor instr and debugger dbgr. In one embodiment, integration code IC is a separate function invoked by debugger dbgr. Alternatively, integration code IC may be part of program progA, instrumentor instr, or debugger dbgr.

In one embodiment, integration code IC analyzes debugging commands input by the user at a debugging prompt. To respond to those commands, integration code IC then invokes appropriate program code, which is generally stored in library lib. Integration code IC may use the functionality of instrumentor instr, debugger dbgr, and/or other code stored in library lib. For example, if the user requests a conditional breakpoint, integration code IC then invokes the functionality of instrumentor instr because instrumentor instr can efficiently respond to that request.

In one embodiment, integration code IC handles breakpoints set in program progA, keeps track of breakpoints, determines the type of a breakpoint, and requests appropriate courses of actions based on the breakpoint types, etc. For example, if a breakpoint is reached, integration code IC determines whether the breakpoint is a standard debugger breakpoint or an instrumentation breakpoint. If the breakpoint is a standard debugger breakpoint, then integration code IC offers standard debugging functionality to the user. However, if the breakpoint is an instrumentation breakpoint, then integration code IC calls one of the handler functions in library lib to start the desired instrumentation.

Integration code IC generates code sequences and performs other complex functions. For example, the condition in a conditional breakpoint, if placed in a trampoline, may require translations into machine instructions. In one embodiment, library lib provides functionality to generate individual instructions while integration code IC translates the conditions into sequences of instructions. Integration code IC then requests library lib to provide free registers, to encode and templatize the code sequence, to place the code sequence into shared memory (e.g., as a trampoline), to add a branch instruction in progA to branch to a trampoline, etc. In one embodiment, once the condition is met, a breakpoint is executed, which transfers control to integration code IC in debugger dbgr. Integration code IC then identifies the breakpoint as “condition-met” and takes appropriate actions, e.g., showing a debugger prompt, removing the trampoline executing the condition, taking corrective actions, etc.

Integration code IC keeps tracks of modifications to the original code that results in the instrumented code and undoes these modifications if necessary. For example, in the disassemble of the binary code of a function, if the binary code is patched with branches to a trampoline or is relocated to shared memory, the disassembly code outputs the changed instructions to a user. If the user does not want to see these changes, the user may request integration code IC to hide or undo these changes.

Debugger dbgr, through integration code IC, can respond to users' requests that generally cannot be performed by a traditional debugger. Together with the functions in library lib, integration code IC can provide answers to questions like “how often has an address been reached,” “how many bundles of instructions of a particular type have been executed,” “what is a call graph (e.g., dynamic, static, context) of a function,” “what is the correlation between a function foo( ) and a function bar( ),” “which blocks or what percentage of a function foo( ) has been reached,” “what percentage of all possible paths in a function foo( ) has been executed,” etc. For example, in response to a user's request how many times a function foo( ) is invoked, integration code IC analyzes this request, arranges programming code into a trampoline that updates a counter at function foo( )'s entry point, and displays the counter value to the user. To provide tools to deal with fault injections, integration code IC simulates programmer errors by modifying the binary code of some modules in program progA and provides the results on how other parts in program progA react to the simulated errors. To provide mechanisms to test whether a memory allocation is successful, integration code IC modifies the return value of the memory allocation function at a specified time, e.g., on every 10^{th} invocation or after the 1000^{th} invocation, etc. To rewrite complex data values and alter control flow to alter the values contained at an address in the data space, integration code IC allows alteration of the value of a variable at runtime if certain conditions are met. For example, at the 1000^{th} iteration of a loop, if a variable Y equals to a first number, e.g., 1000, integration code IC changes a variable X to a second number, e.g., 77, and determines how a variable Z changes. If variable Z is not equal to a third number, e.g., 33 after a fourth line number, e.g., 408 has been reached, then integration code IC halts program progA and provides a debugger prompt to the user, etc.

In one embodiment, integration code IC is invoked by debugger dbgr or the user which specifies the tasks for integration code IC to perform. Debugger dbgr in turns is controlled by several mechanisms, such as instructions in a script file or configuration file. Debugger dbgr together with functions in library lib can enable integration code IC to modify or create new code sequences, commands, or breakpoints, etc.

### The Combined Code

In one embodiment, instrumentor instr, debugger dbgr, and integration code is combined as an independent piece of code, which, for illustration purposes, is referred to as combined code DI. Combined code DI can thus be an independent program or modules integrated into another program application, such as an application server, a database, or any other systems including distributed systems. Combined code DI thus enables the application to perform sophisticated analysis tasks and/or debug components of such application.

Alternatively, combined code DI can be embedded into other language environments, such as the Integrated Development Environment (IDE), which includes Visual Studio from Microsoft of Redmond, Wash. as an example. In one embodiment, the IDE can individually call debugger dbgr, instrumentor instr, or integration code IC directly. The IDE can also allow the various functions of integration code IC to be accessible by the users. The user, through a user interface such as Visual Basic or TCL, is enabled to provide user-defined functions by adding functionality to integration code IC or to combined code DI. Integration code IC (or combined code DI), with additional functionality, in turn offers powerful analysis tools.

In one embodiment, combined code DI is invoked through a configuration file in debugger dbgr, which specifies the functions for DI to execute. For example, the configuration file includes instructions for combined code DI to always count the number of times a function is invoked, to always analyze store instructions for NULL targets, etc. Store instructions for NULL targets usually indicate programming errors, especially in C programming.

Method Steps in Accordance with One Embodiment

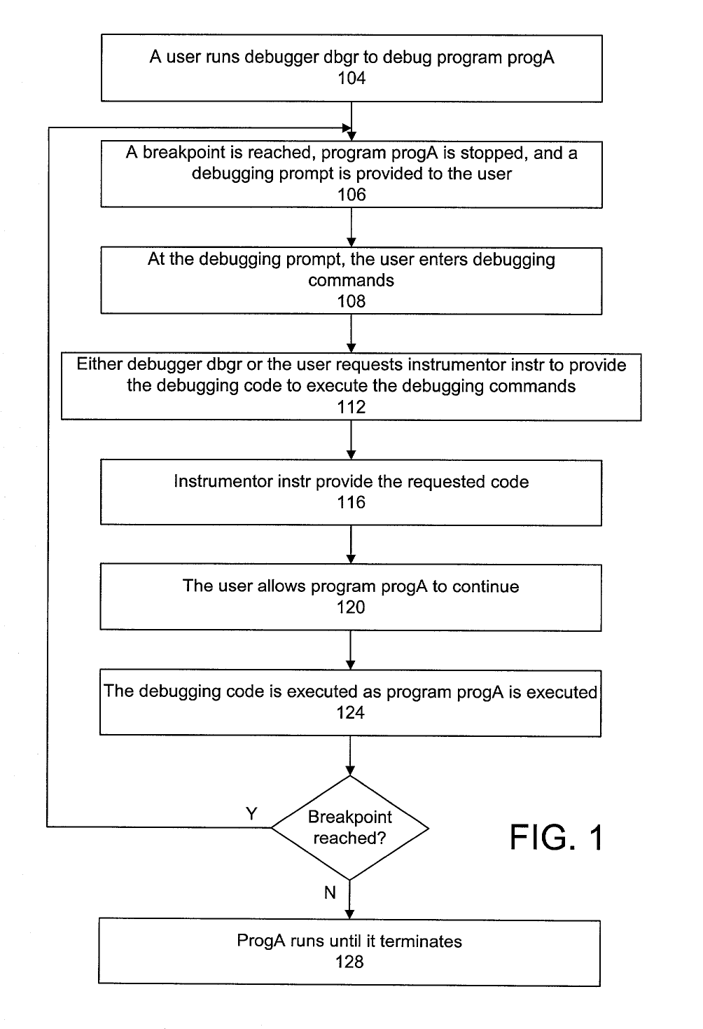

FIG. 1 is a flowchart illustrating the method steps in accordance with one embodiment. In step 104, a user runs debugger dbgr to debug program progA. In one embodiment, the user types the command

dbgr dbgr_pars progA prog_pars

where dbgr_pars and prog_pars may be zero, one, or more than one parameter for debugger dbgr and program progA, respectively. Once the command is executed, debugger dbgr loads program progA, and debugger dbgr and program progA are thus ready to be executed. In step 106, a breakpoint is then reached, program progA is stopped, and a debugging prompt is provided to the user.

In step 108, at the debugging prompt, the user inputs commands to help the user analyze and thus debug program progA. Exemplary commands include counting the number of times a function is invoked, executing instructions until a condition is met before stopping at a breakpoint, generating watchpoints, etc.

In step 112, either debugger dbgr or the user, through integration code IC, requests that the code to execute the commands input by the user be provided. In one embodiment, integration code IC requests instrumentor instr to provide such code. In this example, instrumentor instr can be any other program. However, instrumentor instr is used because it greatly augments debugger dbgr as it traditionally performs well the function of modifying and adding programming code.

In step 116, instrumentor instr provides the requested code. In one embodiment, instrumentor instr provides the code in trampoline trmpl and inserts a branch instruction to trampoline trmpl in program progA so that trampoline trmpl can be executed when the branch instruction is reached. In step 120, the user allows program progA to continue. In step 124, because trampoline trmpl is an executable part of progA, trampoline trmpl is executed when it is reached while progA is executed.

In the above illustration, various breakpoints may exist in progA by various methods. For example, a programmer may insert the breakpoints when he wrote program progA, a user may insert breakpoints while he is at a breakpoint, or instrumentor instr may insert breakpoints, e.g., to start instrumentation of a function or to find when execution of a function has finalized, etc. At each of the breakpoints being reached while progA is executed, the user may input debugging commands as in step 108, and the method of FIG. 1 proceeds in accordance with steps 112 to 124. If there is no other breakpoint, then progA in step 128 continues execution until termination.

### Applications to Conditional Breakpoints

Conditional breakpoints are breakpoints that are executed only if a certain condition is met. For example, if X=5, then stop at address Y; if (Z>10) and W<7), then invoke function U, etc. In one embodiment, when the user sets a conditional breakpoint, the condition is tested in trampoline trmpl until the condition is met, and, at that time, the program flow is transferred to debugger dbgr. This embodiment advantageously improves system performance especially when the condition is in a loop because trampoline trmpl, or program progA, is continually executed without being interrupted due to the execution transfer between progA and debugger dbgr as in other approaches.

Traditionally, a non-conditional breakpoint would be placed in progA, and when the breakpoint is reached, program control is transferred to debugger dbgr, which would cause numerous transfers between debugger dbgr and program progA in loop situations. This is because after a condition is tested in debugger dbgr, program control is transferred to progA in which the condition is not met. Program progA then continues to run until it reaches the same breakpoint wherein the program control is again transferred to debugger dbgr. The loop including the condition is executed causing the transfer between debugger dbgr and program progA to continue until the condition is met. As an example, if the loop is 1,000 times, the disclosed techniques test for the condition approximately 1,000 times in trampoline trmpl and transfer to debugger dbgr only one time. In contrast, a traditional approach would have to transfer between debugger dbgr and progA approximately 1,000 times.

### Applications to Watchpoints

Generally, a watchpoint for a variable is executed if a certain condition related to a memory location for that variable is met. For example, a message is sent to the user when the variable is used or receives a new value. In one embodiment, the watch code for the variable including the condition to be met is dynamically inserted in the original code of progA. Alternatively, the code may be part of trampoline trmpl. If the watchpoint condition is met, then the code allows the watchpoint to be executed and execution control is transferred to debugger dbgr. In one embodiment, to check whether a variable has been changed, the code determines whether the variable is a target of a store command, i.e., whether the memory address of the variable is used in a store command. For example, if the memory address of an integer I is 5, then a store command storing a value to address 5 indicates that the value of integer I has been changed. Similarly, to check whether the variable I has been used, the code determines whether that variable I is the target of a load command because a load command loading a value from address 5 indicates that integer I has been used. To check whether a variable has been initialized, the code determines whether the variable is the target of a store then a load command. Un-initialized variables may be considered programming bugs that can cause unwanted behavior in program progA.

The above disclosed techniques are much faster than traditional approaches in which a debugger single steps through program progA and checks for the content of the variable at every memory access to determine whether the variable has been changed. The disclosed techniques are also much simple than the approaches in which a watchpoint is executed when memory is accessed in a critical region because these approaches usually require interaction between the operating system and the debugger. Additionally, it is very difficult for a user using only a debugger to find un-initialized variables.

### Computer System Overview

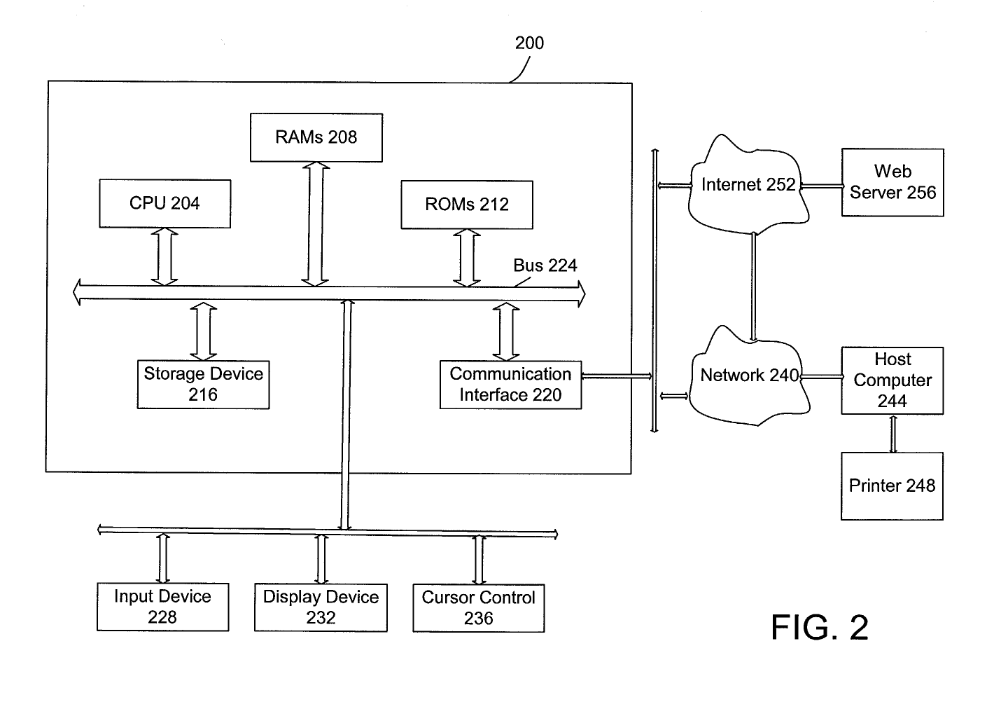

FIG. 2 is a block diagram showing a computer system 200 upon which embodiments of the invention may be implemented. For example, computer system 200 may be implemented to run instrumentor instr, debugger dbgr, trampoline trmpl, etc., to perform functions in accordance with the techniques described above. In one embodiment, computer system 200 includes a processor 204, random access memories (RAMs) 208, read-only memories (ROMs) 212, a storage device 216, and a communication interface 220, all of which are connected to a bus 224.

Processor 204 controls logic, processes information, and coordinates activities within computer system 200. In one embodiment, processor 204 executes instructions stored in RAMs 208 and ROMs 212, by, for example, coordinating the movement of data from input device 228 to display device 232.

RAMs 208, usually being referred to as main memory, temporarily store information and instructions to be executed by processor 204. Information in RAMs 208 may be obtained from input device 228 or generated by processor 204 as part of the algorithmic processes required by the instructions that are executed by processor 204.

ROMs 212 store information and instructions that, once written in a ROM chip, are read-only and are not modified or removed. In one embodiment, ROMs 212 store commands for configurations and initial operations of computer system 200.

Storage device 216, such as floppy disks, disk drives, or tape drives, durably stores information for used by computer system 200.

Communication interface 220 enables computer system 200 to interface with other computers or devices. Communication interface 220 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 220 may also allow wireless communications.

Bus 224 can be any communication mechanism for communicating information for use by computer system 200. In the example of FIG. 2, bus 224 is a media for transferring data between processor 204, RAMs 208, ROMs 212, storage device 216, communication interface 220, etc.

Computer system 200 is typically coupled to an input device 228, a display device 232, and a cursor control 236. Input device 228, such as a keyboard including alphanumeric and other keys, communicates information and commands to processor 204. Display device 232, such as a cathode ray tube (CRT), displays information to users of computer system 200. Cursor control 236, such as a mouse, a trackball, or cursor direction keys, communicates direction information and commands to processor 204 and controls cursor movement on display device 232.

Computer system 200 may communicate with other computers or devices through one or more networks. For example, computer system 200, using communication interface 220, communicates through a network 240 to another computer 244 connected to a printer 248, or through the world wide web 252 to a server 256. The world wide web 252 is commonly referred to as the “Internet.” Alternatively, computer system 200 may access the Internet 252 via network 240.

Computer system 200 may be used to implement the techniques described above. In various embodiments, processor 204 performs the steps of the techniques by executing instructions brought to RAMs 208. In alternative embodiments, hard-wired circuitry may be used in place of or in combination with software instructions to implement the described techniques. Consequently, embodiments of the invention are not limited to any one or a combination of software, hardware, or circuitry.

Instructions executed by processor 204 may be stored in and carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic, or light waves, etc. As an example, the instructions to be executed by processor 204 are in the form of one or more software programs and are initially stored in a CD-ROM being interfaced with computer system 200 via bus 224. Computer system 200 loads these instructions in RAMs 208, executes some instructions, and sends some instructions via communication interface 220, a modem, and a telephone line to a network, e.g. network 240, the Internet 252, etc. A remote computer, receiving data through a network cable, executes the received instructions and sends the data to computer system 200 to be stored in storage device 216.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for augmenting a debugger having debugging functionality used to debug a first program, comprising the steps of:
providing the debugger;
providing a second program having second-program functionality; and
providing integration code for
analyzing commands used to debug the first program, and
invoking appropriate pieces of code to perform tasks in responding to such commands;
wherein the appropriate pieces of code are selected from one or a combination
of
functionality provided in a library,
the debugging functionality, and
the second-program functionality.

2. The method of claim 1 further comprises the step of using an instrumentor as the second program.

3. The method of claim 1 further comprises the step of using a first piece of code having the appropriate pieces of code to perform the tasks.

4. The method of claim 3 further comprises the step of making the first piece of code an executable part of the first program.

5. The method of claim 3 further comprises the step of using a trampoline as the first piece of code.

6. The method of claim 1 wherein the commands are selected from one or a combination of:
input from a user using the debugger;
a script file associated with the first program; and
a configuration file associated the first program.

7. The method of claim 1 further comprises the step of inputting the commands at a debugging prompt provided by the debugger.

8. The method of claim 1 further comprises the steps of:
integrating the debugger, the instrumentor, and the integration code into a combined code; and
embedding the combined code into a language environment.

9. The method of claim 8 further comprises the step of using the Integrated Development Environment as the language environment.

10. A system for augmenting a debugger having debugging functionality used to debug a first program, comprising:
the debugger;
a second program having second-program functionality; and
integration code for
analyzing commands used to debug the first program, and
invoking appropriate pieces of code to perform tasks in responding to such commands;
wherein the appropriate pieces of code are selected from one or a combination
of
functionality provided in a library,
the debugging functionality, and
the second-program functionality.

11. The system of claim 10 further comprises an instrumentor used as the second program.

12. The system of claim 10 further comprises a first piece of code having the appropriate pieces of code to perform the tasks.

13. The system of claim 12 wherein the first piece of code is an executable part of the first program.

14. The system of claim 12 wherein a trampoline is used as the first piece of code.

15. The system of claim 10 wherein the commands are selected from one or a combination of:
input from a user using the debugger;
a script file associated with the first program; and
a configuration file associated the first program.

16. The system of claim 10 wherein the commands are input at a debugging prompt provided by the debugger.

17. The system of claim 10 wherein:
the debugger, the instrumentor, and the integration code are integrated into a combined code; and
the combined code is embedded in a language environment.

18. The system of claim 17 wherein the Integrated Development Environment is used as the language environment.

19. A computer-readable medium embodying instructions that cause a computer to perform a method for augmenting a debugger having debugging functionality used to debug a first program, the method comprising the steps of:
providing the debugger;
providing a second program having second-program functionality; and
providing integration code for
analyzing commands used to debug the first program, and
invoking appropriate pieces of code to perform tasks in responding to such commands;
wherein the appropriate pieces of code are selected from one or a combination
of
functionality provided in a library,
the debugging functionality, and
the second-program functionality.

20. The computer-readable medium of claim 19 wherein the method further comprises the step of using an instrumentor as the second program.
